(19) United States
(12) Patent Application Publication
(10) Pub. No.: US 2026/0144242 A1
(43) Pub. Date: May 28, 2026

(54) BULLETS FOR FISHING

(71) Applicant: Todd Terwilliger, Norton, OH (US)

(72) Inventor: Todd Terwilliger, Norton, OH (US)

(21) Appl. No.: 19/407,426

(22) Filed: Dec. 3, 2025

Related U.S. Application Data
(60) Provisional application No. 63/724,515, filed on Nov. 25, 2024.

(51) Int. Cl. A01K 95/00; A01K 85/00; A01K 85/01

(52) U.S. Cl. CPC A01K 95/005; A01K 85/015; A01K 85/017; A01K 85/018; A01K 85/1847

(57) ABSTRACT

Texas rig fishing is an effective method of fishing, particularly suited for bass, that allows anglers to fish in bodies of water with significant submerged vegetation or other obstacles that may make maneuvering a traditional fishing line and lure difficult. For these applications, a weight is added to the line near the hook to improve the ability for the angler to control the depth of the lure and the maneuverability of the fishing lure. These weights are called bullets. The present invention relates to an improved bullet design that reduces the risk of the fishing lure being entangled by underwater vegetation or other obstacles, protects the soft plastic lure from wear, and prevents breakage throughout the entire fishing process while also removing the need to peg the bullet or use a bobber stop.

### CROSS-REFERENCE TO RELATED APPLICATIONS

This non-provisional application claims priority to U.S. Provisional Patent Application Ser. No. 63/724,515, filed on Dec. 3, 2024.

### I. BACKGROUND

### A. Technical Field

This invention pertains to the field of bullets used for fishing, particularly Texas rig fishing.

### B. Description of Related Art

Traditional Texas rig fishing is an effective method of fishing, particularly suited for bass, that allows anglers to fish in bodies of water with significant submerged vegetation or other obstacles that may make maneuvering a traditional fishing line and lure difficult.

Texas rig fishing can be fished weightless or weighted. Many fishermen prefer to fish with a “weightless” lure 10 (not using a weight) as shown in FIG. 1 to enable the lure to either float at the top of the water or descend slowly through the water, which attracts fish. However, a weightless lure tends to get snagged in weeds and brush in the water. A weightless lure is also blown around in windy or water wave conditions.

These problems are reduced by the weighted method as shown in FIG. 2 in which a weight 12 is added to the lure 10 which deflects the weeds and brush and keeps the lure and line stable in windy or wavey conditions. For weighted applications, a cone or bullet shaped weight called a bullet weight can be incorporated. This improves the anglers ability to control the lure casting distance, the lure rate of fall in the water, and the maneuverability of the lure through grass and other obstacles. The bullet weight helps the angler stay in contact with the bottom of a body of water. The bullet weight can make sounds on rocks and wood that can draw fish to bite.

The weightless Texas rig of FIG. 1 is considered a finesse-style approach, relying on the lure's inherent action and presentation that draws fish to bite. Weights tend to cause the lure to sink too quickly and do not allow the lure to shimmy or move freely through the water in a manner to attract the fish. So weighted and weightless applications are each desirable for different conditions. However, it can be a time consuming process to add or remove a weight under varying conditions.

With both the weighted and the weightless Texas rigs, the soft plastic lure 10 is secured to a hook 20, most commonly an offset hook, in a manner that is weedless, where the hook point is buried back into the lure to prevent the hook point from snagging, as also shown in FIG. 1. However, as shown in FIG. 4, when used with a wide gap hook 30 having a hook eye 32, a hook point, 34, and a shoulder bend area 36, the tip of the soft plastic lure 10 tends to wear, tear, and slide off the wide gap hook shoulder bend area as shown in FIG. 3 when fishing the weightless or weighted Texas rig method.

After a few skip casts, a few snags, or even a single thrashing fish catch, the traditional Texas rig soft plastic lure can quickly wear out at the hook shoulder bend area of the lure and become unusable, as shown in FIG. 3. The lure tip wear will allow the tip of the lure to unwantedly slide off the hook shoulder bend area rendering the lure ineffective. Cast after cast, the slipping increases until the lure is unusable and a new lure must be rigged, which is also time consuming and wasteful of a lure.

A traditional Texas rig bullet weight is solid and cannot be used in a weightless application. The traditional weightless Texas rig does not have a bullet to navigate through the various forms of cover. The benefits of weighted and weightless applications are only available in either application, and the benefits of each application are not obtainable in the other.

A peg is typically a toothpick-like structure, wedged between the line and the bullet weight from the backside of the bullet weight, that keeps the bullet in a desired position relative to the hook. The bullet bobber stop is similarly used but is placed in front of the bullet weight to keep the bullet in a desired position relative to the hook. These two methods are less prone to getting hung up in heavy cover. Without the bobber stop, the traditional bullet weight would sink down in the water first and then the lure would follow. This presentation is sometimes desirable to an angler when hang-ups are not a problem.

### II. SUMMARY

Provided in this disclosure is a fishing lure bullet weight including a bullet-shaped exterior body and a hollow interior chamber surrounded by an inside surface of the exterior body with an open end at a bottom of the exterior body. The interior chamber is configured to receive and retain a tip of a fishing lure through the open end. An aperture is formed in a side of the exterior body. The aperture is formed as a void space between an outside surface of the exterior body and the inside surface surrounding the hollow interior chamber. An anchor is formed into the side of the exterior body defined by shapes and features of the aperture. The anchor is configured to engage and retain a fishing hook inserted into the chamber and looped through the aperture between the inside and outside surfaces of the exterior body.

In another aspect of the fishing lure bullet weight, the aperture includes a vertical channel extending upwardly from the open end. The aperture curves from the vertical channel into a horizontal channel parallel to the open end. The aperture curves from the horizontal channel into a tapering channel extending downwardly toward the open end and terminates in a flared channel having a larger opening than the tapered channel.

In a further aspect of the fishing lure bullet weight, the flared channel of the aperture is dimensioned to engage and retain the fishing hook when inserted into the chamber and looped through the aperture between the inside and outside surfaces of the exterior body. The flared channel is dimensioned to engage and retain a shoulder bend area of a wide bend fishing hook, so that the hook thereby applies pressure to securely retain the fishing lure inside the chamber against the inside surface of the exterior body.

In an additional aspect of the fishing lure bullet weight, the exterior body is formed of a resin having a density less than that of water to form a weightless bullet. The exterior body also includes an open point at an opposite end from the open end for threading a fishing line through the exterior body to the lure and the fishing hook. The bullet-shaped exterior body includes a generally cylindrical side wall terminating at the open end and a generally conical tapered tip opposite the open end.

In yet another aspect of the fishing lure bullet weight, the hollow interior chamber is sized to receive one or more additional objects including additional weight, light-emitting objects, sound-emitting objects or scent-emitting material. The exterior body includes one or more vent slots for admitting the passage of light, sound, or scent from the at least one additional object to attract a fish.

A method is provided herewith including steps of providing a bullet weight comprising an exterior body, a hollow interior chamber, an open end at a bottom of the exterior body, open point at an opposite end from the open end, an aperture formed in a side of the exterior body, and an anchor formed into the side of the exterior body defined by shapes and features of the aperture. A fishing line is threaded through the open point. A fishing lure is hooked onto a wide gap hook attached to the fishing line. The bullet weight is slid along the fishing line to encapsulate a hook eye of the wide gap hook and a tip of the fishing lure so that a shoulder bend of the hook is secured through aperture. The shoulder bend is pushed vertically upwardly into a first channel of the aperture. The shoulder bend is turned horizontally into a second channel of the aperture. The shoulder bend is turned vertically downward into a third channel of the aperture into a flared channel to lock the shoulder bend against the anchor, to lock the hook and lure into the bullet.

In another aspect of the method, after the step of threading and before the step of sliding, a step is performed of adding at least one additional object into the chamber. The step of adding one or more additional objects includes adding additional weight, light-emitting objects, sound-emitting objects or scent-emitting material. The step of sliding the bullet weight up the line also includes encapsulating the additional objects into the chamber.

In a further aspect of the method, the first channel of the aperture is a vertical channel extending upwardly from the open end. The second channel of the aperture is a horizontal channel parallel to the open end that curves away from the vertical channel. The third channel of the aperture is a tapering channel extending downwardly toward the open end from the horizontal channel and terminates in the flared channel having a larger opening than the tapered channel. The step of hooking the fishing lure onto the wide gap hook attached to the fishing line is performed in accordance with a standard Texas rig method.

Other benefits and advantages of this invention will become apparent to those skilled in the art to which it pertains upon reading and understanding of the following detailed specification.

### III. BRIEF DESCRIPTION OF THE DRAWINGS

The disclosed fishing lure bullet weight may take physical form in certain parts and arrangement of parts, embodiments of which will be described in detail in this specification and illustrated in the accompanying drawings which form a part hereof and wherein:

FIG. 1 shows a traditional weightless Texas rig lure.

FIG. 2 shows a traditional Texas rig with a traditional bullet weight and bobber stop.

FIG. 3 shows a traditional weightless Texas rig lure that slipped off the shoulder bend area, resulting in damage to the lure.

FIG. 4 shows a typical wide gap hook.

FIG. 5 shows a short bullet disconnected from the wide gap hook and soft plastic lure in accordance with an exemplary embodiment.

FIGS. 6A and 6B are respective side and cross-sectional views along line A-A of a bullet in accordance with an exemplary embodiment.

FIG. 7 is a side cross-sectional view of a bullet in accordance with an exemplary embodiment.

FIG. 8 is a perspective phantom view of a bullet in accordance with an exemplary embodiment.

FIG. 9 is a perspective view comparing short and long bullet designs in accordance with an exemplary embodiment.

FIG. 10 shows a short bullet attached to a wide gap hook and soft plastic lure in accordance with an exemplary embodiment.

FIG. 11 shows a short bullet attached to a wide gap hook and soft plastic lure in accordance with an exemplary embodiment.

FIG. 12 shows a short bullet attached to a wide gap hook and soft plastic lure that has been swallowed by a fish with the soft plastic lure tip remaining in position at the hook shoulder bend area in accordance with an exemplary embodiment.

FIG. 13 shows a short bullet attached to a wide gap hook and soft plastic lure that has been swallowed by a second fish with the soft plastic lure tip remaining in position at the hook shoulder bend area in accordance with an exemplary embodiment.

FIG. 14 shows a short bullet attached to a wide gap hook and soft plastic lure that has been swallowed by a fish with the soft plastic lure tip remaining in position at the hook shoulder bend area in accordance with an exemplary embodiment.

FIG. 15 shows a short bullet attached to a wide gap hook and soft plastic lure that has been swallowed by a fish with the soft plastic lure tip remaining in position at the hook shoulder bend area in accordance with an exemplary embodiment.

FIG. 16 shows a Texas rig assembly having the present bullet with two small tungsten beads in the chamber for light additional weight and a subtle sound in accordance with an exemplary embodiment.

FIG. 17 shows a Texas rig assembly having the present bullet with one large glass bead for a unique one knocker sound in accordance with an exemplary embodiment.

FIG. 18 shows a Texas rig assembly having the present bullet with one 8 mm tungsten bead for needed weight to get the lure to the bottom quick in accordance with an exemplary embodiment.

FIG. 19 shows a Texas rig assembly having the present bullet with one 3/16 oz tungsten bullet for needed weight and a one knocker type sound in accordance with an exemplary embodiment.

FIG. 20 shows a Texas rig with the present bullet in accordance with an exemplary embodiment.

FIG. 21 shows a Texas rig with the present bullet and without a bobber stop in accordance with an exemplary embodiment.

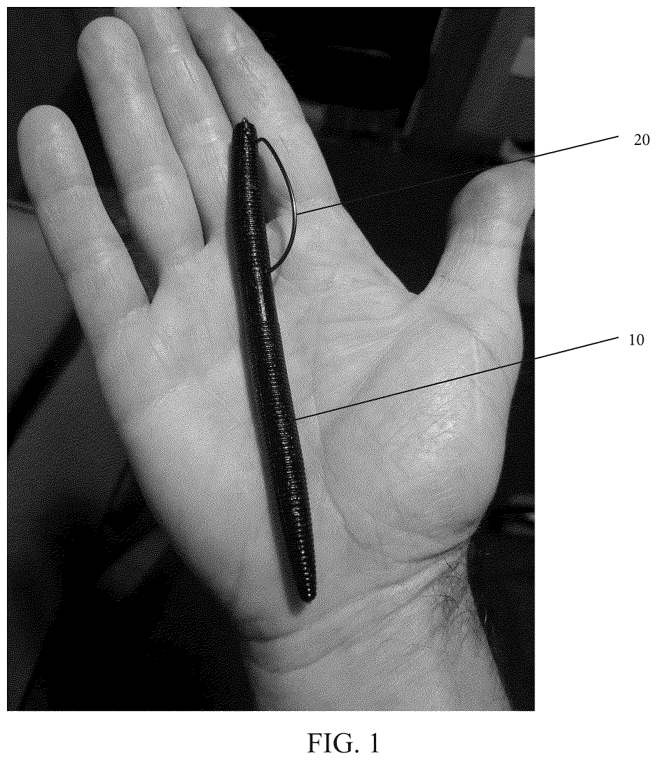

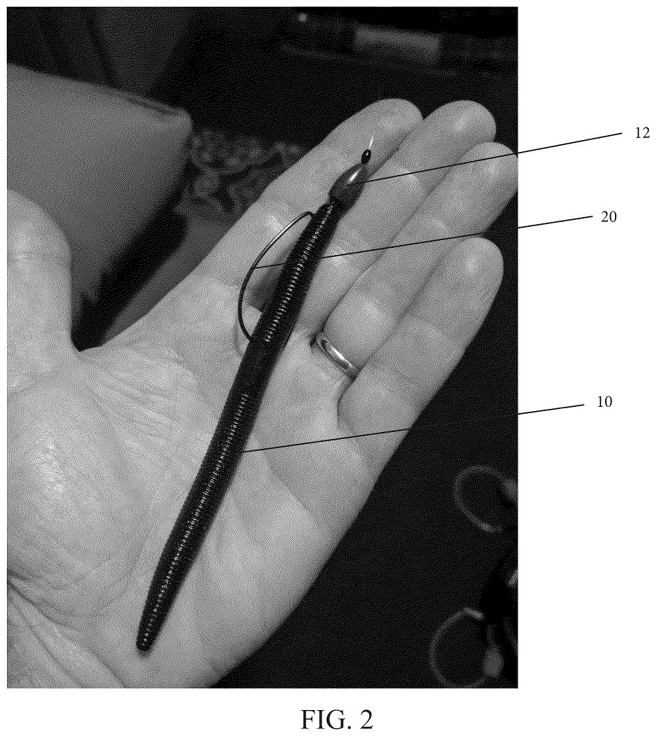

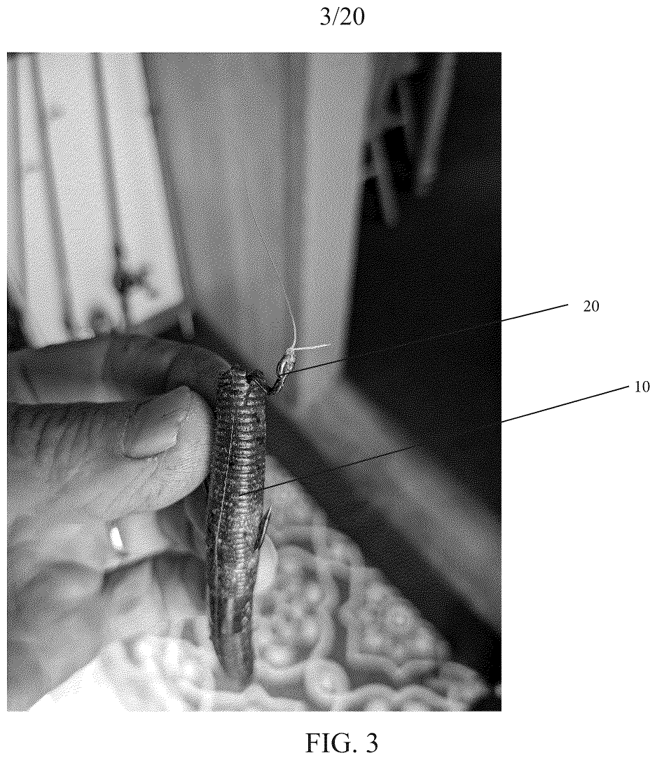

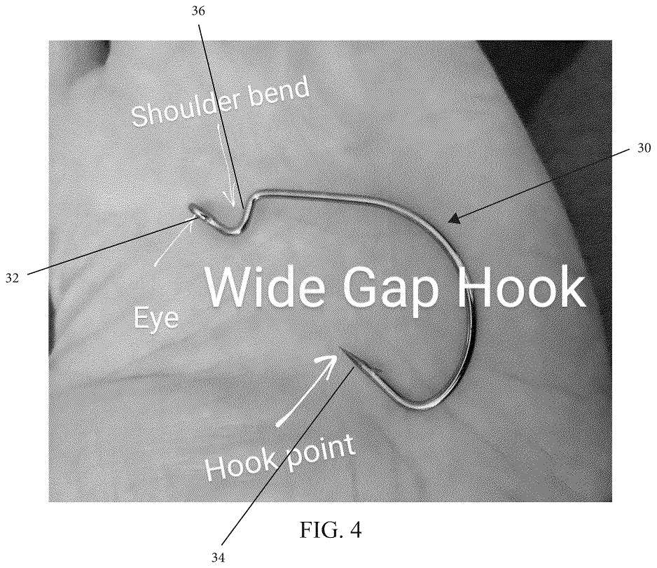

### IV. DETAILED DESCRIPTION

Referring now to the drawings wherein the showings are for purposes of illustrating embodiments of the article only and not for purposes of limiting the same, and wherein like reference numerals are understood to refer to like components:

Reference is now made to the drawings wherein the showings are for purposes of illustrating embodiments of the article only and not for purposes of limiting the same, and wherein like reference numerals are understood to refer to like components.

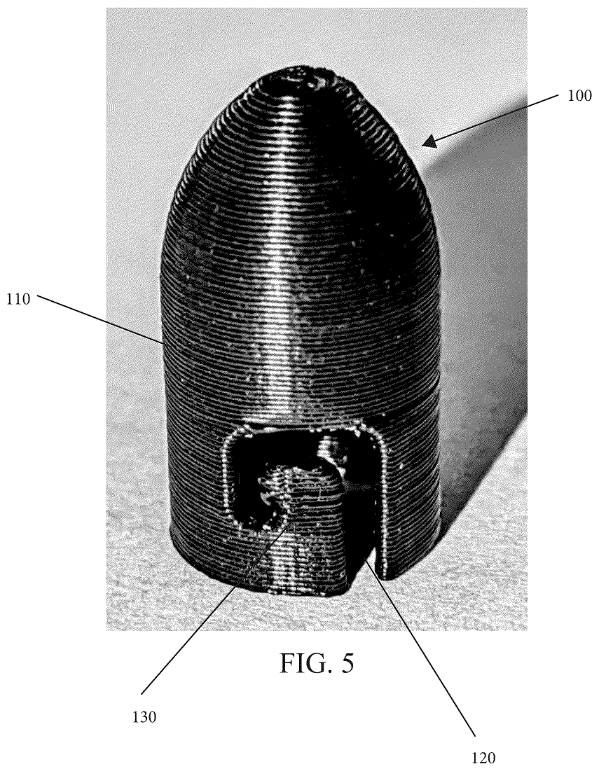

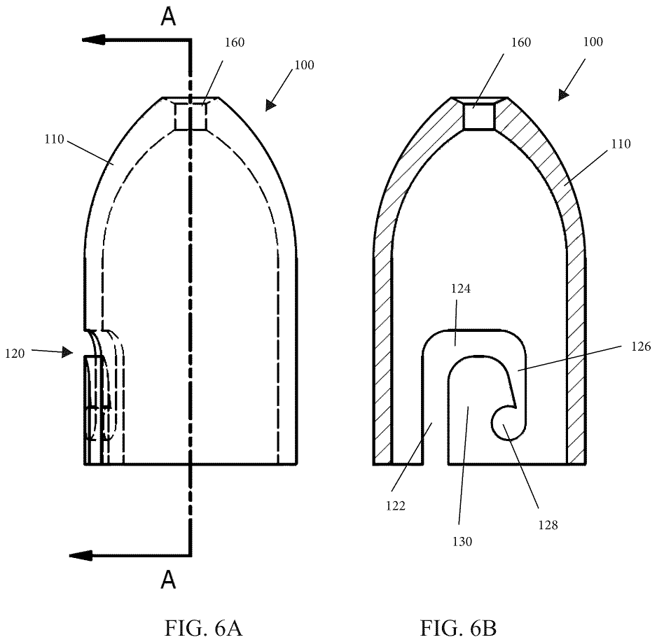

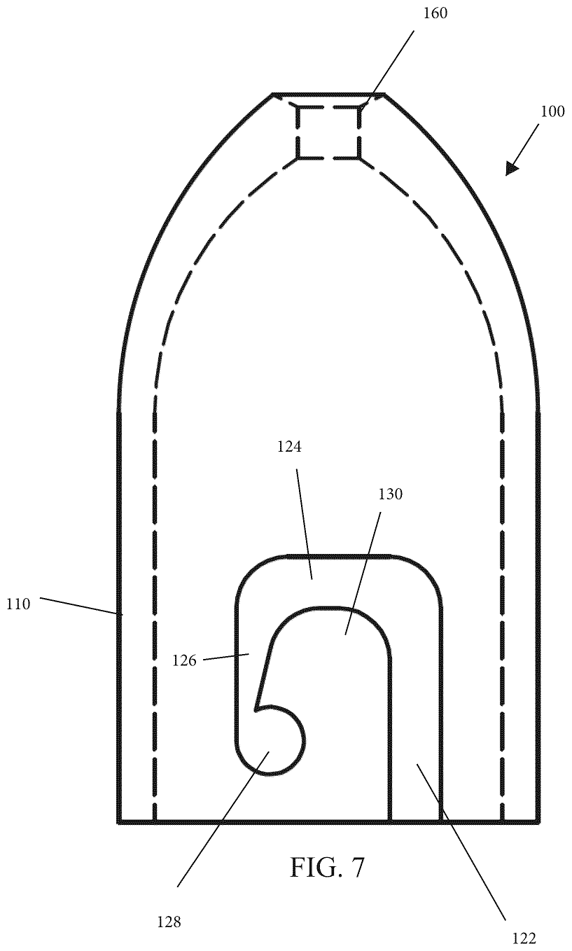

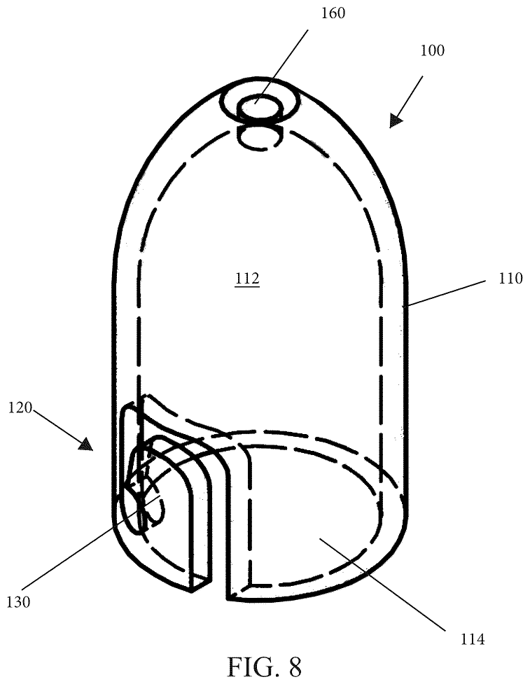

As shown in FIGS. 5, 6A, 6B, 7, 8, and 9, a bullet 100 has an exterior body 110 that surrounds a hollow inside chamber 112 with an open end 114 at the bottom of the bullet 100. An aperture 120 is formed in the side of the body 110 and includes an upwardly extending vertical channel 122 that curves into a horizontal channel 124 and then extends downward into a tapering channel 126 that terminates in a flared channel 128, which is a larger opening than the tapered channel 126. The shape and features of the aperture 120 results in an anchor 130 formed into the side of the body 110.

With respect to the bullet 100 shown in FIGS. 5, 6A, 6B, 7, 8, and 9, in one exemplary embodiment, the bullet 100 can be 0.71 in. tall and 0.41 in. wide from one side of the exterior body 110 to the other. The hollow inside chamber 112 can be 0.34 in. across the open end 114. The aperture 120 can be 0.26 in. tall across the vertical channel 122 and 0.20 in. wide across the horizontal channel 124. The tapering channel 126 and flared channel 128 can be 0.21 in. tall. The anchor 130 can be 0.21 in. tall and 0.13 in. wide within the aperture 120. An open point 160 at the top of the bullet 100 can be 0.06 in. in diameter.

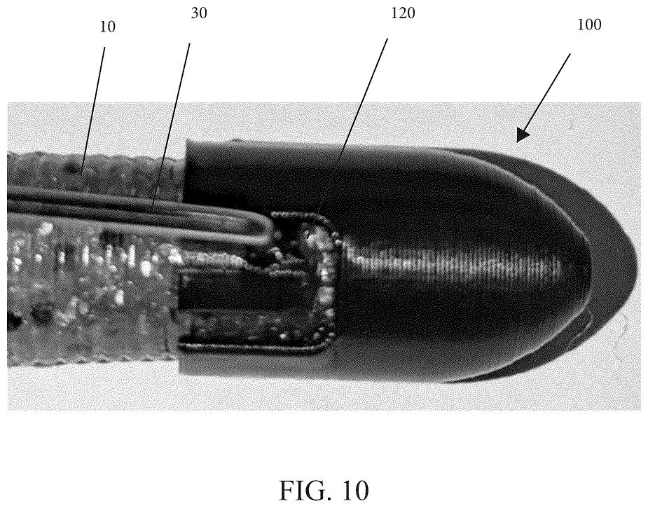

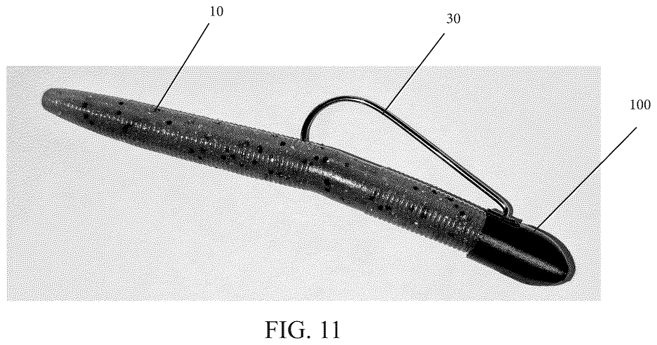

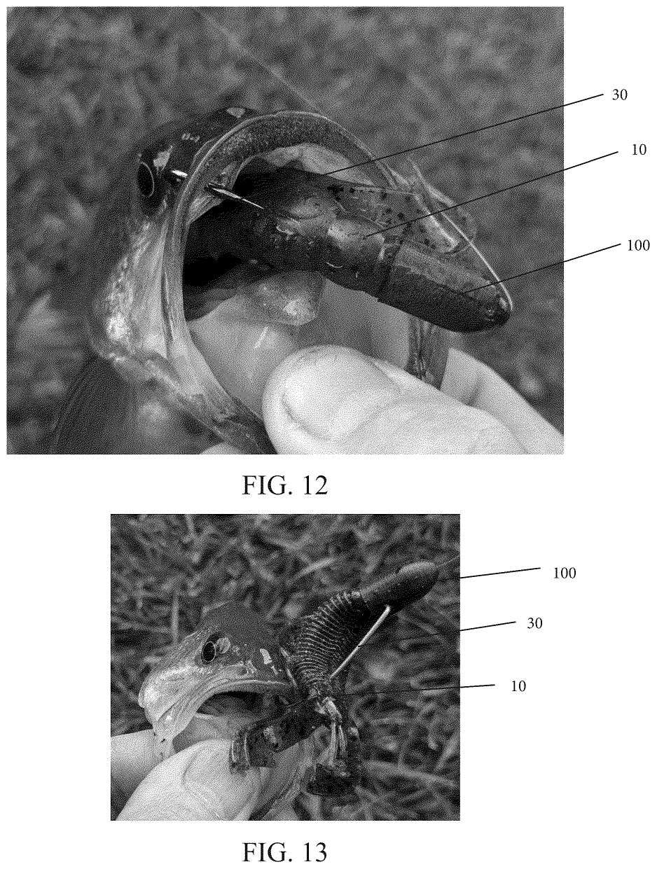

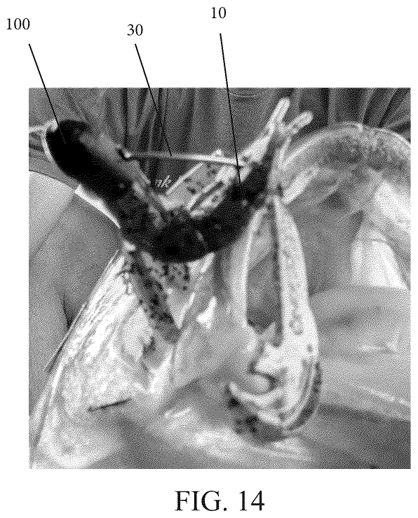

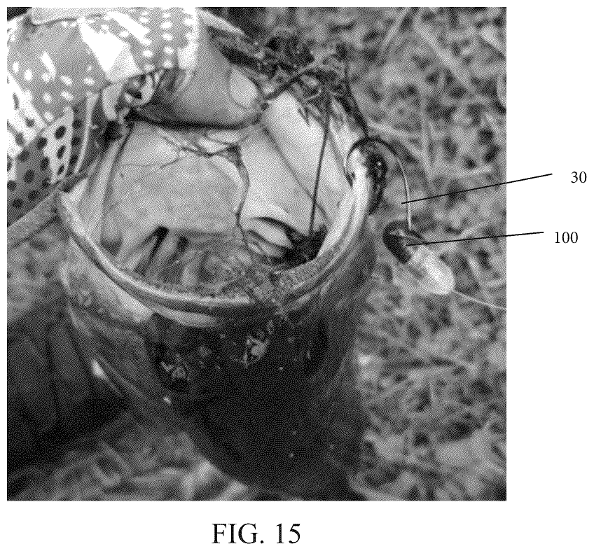

As shown, for example, in FIGS. 10 and 11, the lure 10 with the hook 30 is inserted into the chamber 112 and the hook 20 is looped over into the flared channel 128 to be engaged and retained by the anchor 130. In this way, the bullet 100 is configured to protect the tip of the soft plastic lure 10 from wearing, tearing, and sliding off the shoulder bend area 36 of the wide gap hook 30 when fishing the weightless or weighted Texas rig method. The bullet 100 thus keeps the lure 10 secure to the shoulder bend area 36 of the wide gap hook 30, thereby extending the life of the lure 10, and assures the action and presentation of the lure 10. FIGS. 12-15 show various results where a wide gap hook 30 with a soft plastic lure 10 has been swallowed by a fish the soft plastic lure 10 with the tip remaining in position at the hook shoulder bend area 36.

As generally depicted in the figures, the bullet 100 according to the present invention can be effectively weightless for Texas rig fishing. In one exemplary embodiment, the bullet 100 can be made of a resin having a density less than that of water, at approximately 0.97g/cm3 . The weightless bullet 100 performs better than the traditional weightless Texas rig by providing a bullet shape that breaks through various types of cover and can even be navigated through mats and lily pads, thereby providing the benefits of both weightless and weighted fishing.

As also shown, for example, in FIGS. 10 and 11, the bullet 100 does not require a bullet peg or bobber stop to stay in position. The aperture 120 provides a “push, turn, pull” configuration for securing the bullet 100 to the shoulder bend area 36 of the wide gap hook 30 to the anchor 130, while simultaneously encapsulating and securing the tip of the soft plastic lure 10. This configuration of the anchor 130 keeps the lure tip on the shoulder bend 36 and free from damage throughout the fishing process and additionally avoids snagging weeds and other submerged obstacles that can damage the lure 10 to ensnare, or otherwise impair the mobility of the lure 10.

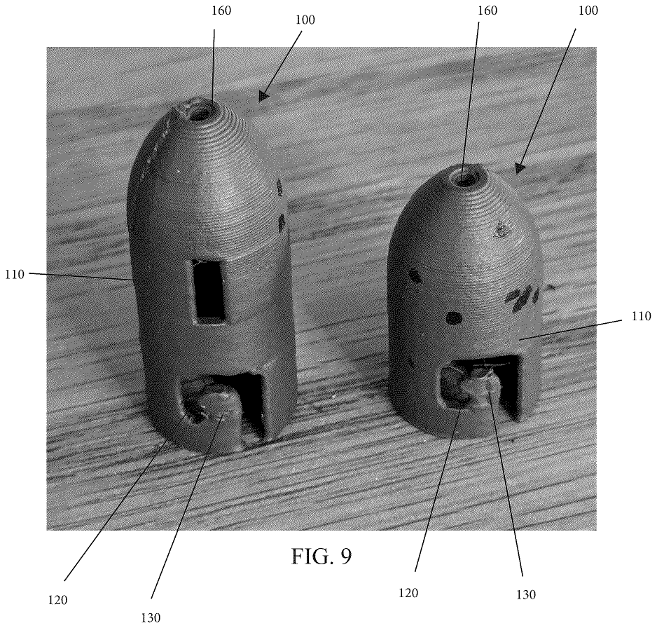

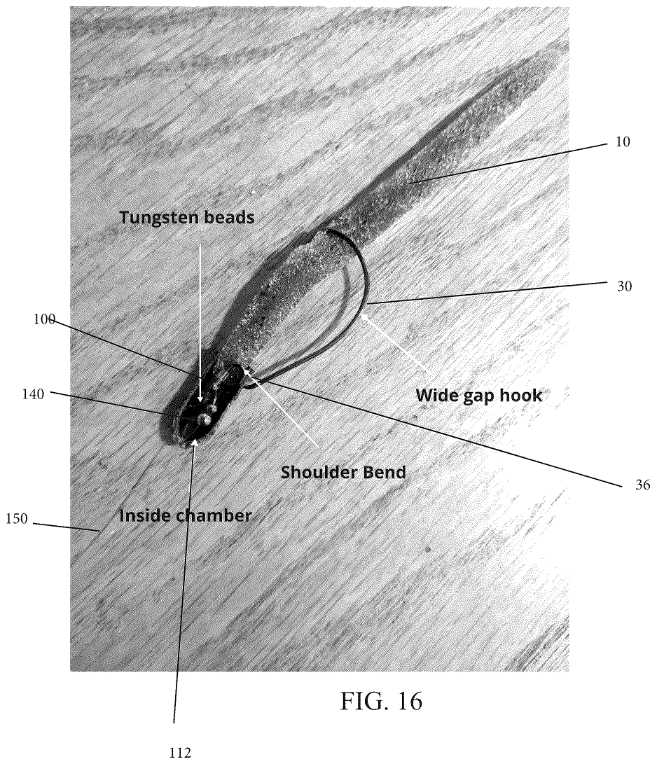

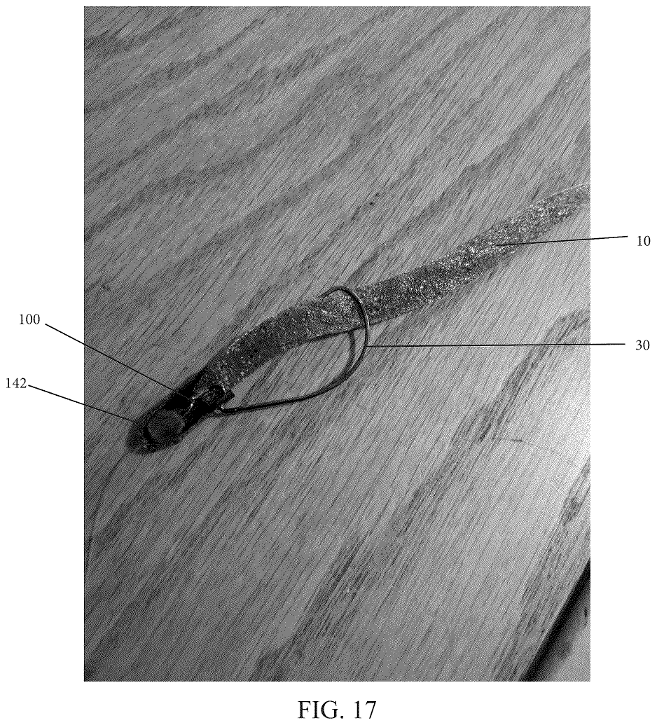

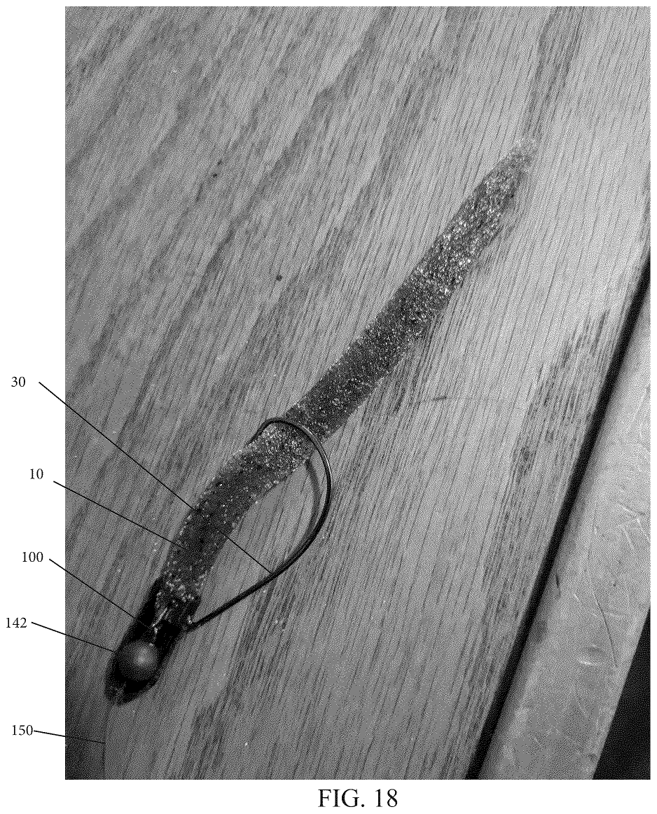

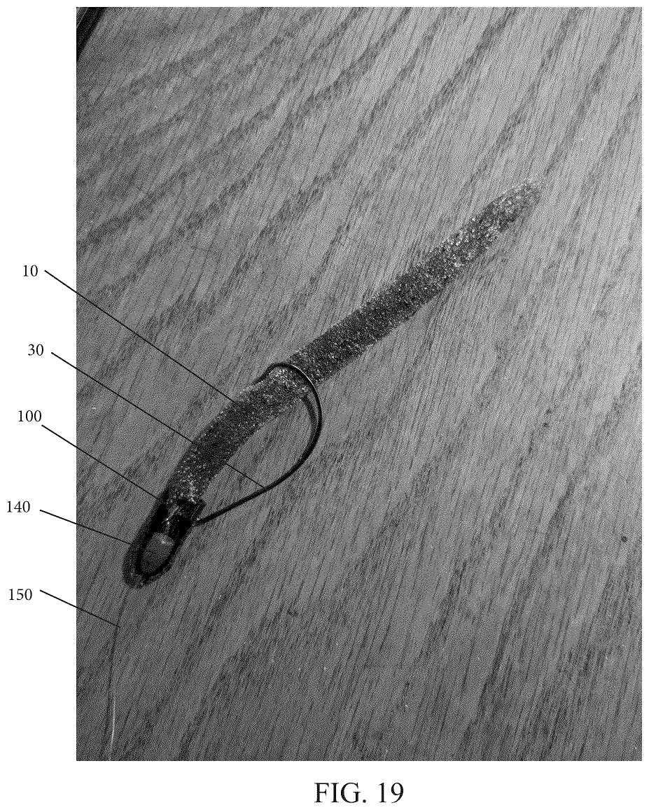

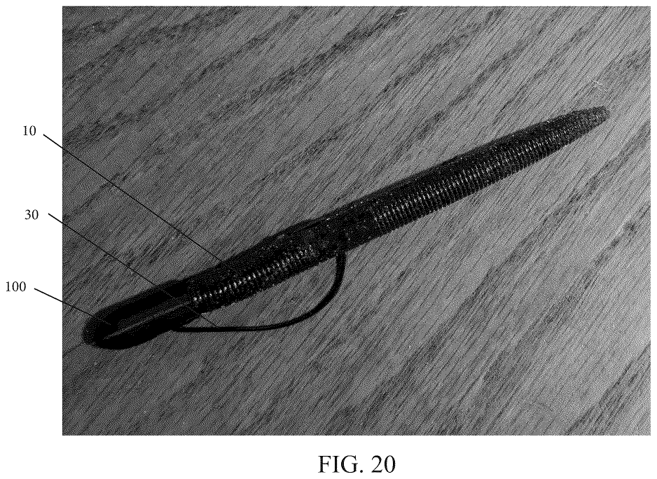

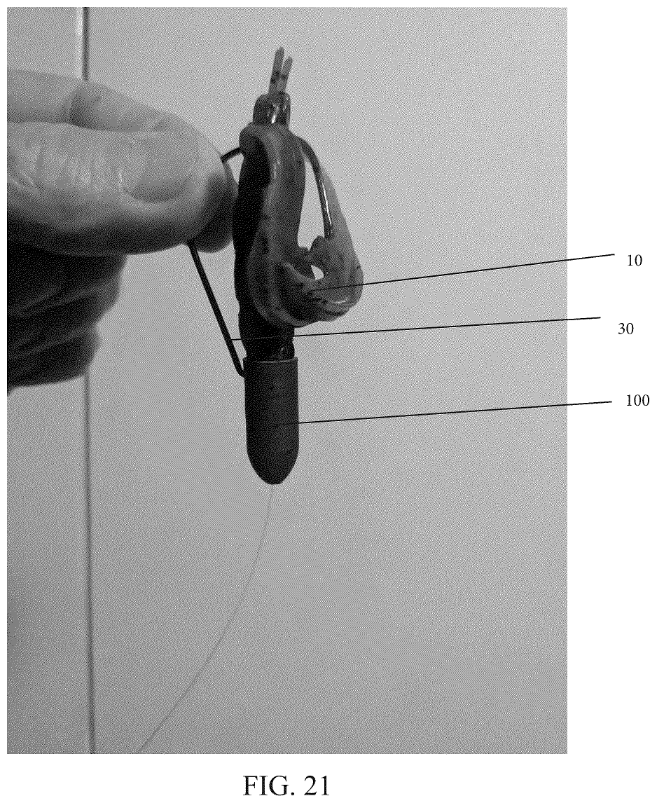

As shown in FIGS. 16, 17, 18, and 19, the hollow inside chamber 112 of the bullet 100 allows for added weight or beads 140 or various other materials to be added, including sound and/or scent. For example, the hollow inside chamber 112 can receive scented beads 140 or a scent such as a fish attractant soaked onto a cotton ball, or glow beads 142 used with a clear bullet 100 to glow in the dark, or even fish food. As depicted in FIG. 9, a long bullet 100a can have a longer inside chamber 112 for receiving more weight or other material. Alternatively, a short bullet 110b can have a smaller inside chamber 112, while still having some room for weights, sounds, or scents.

As shown in FIGS. 5, 6A, 6B, 7, 8, and 9, both long and short bullets 110a, 100b have a vent slot 144 for the releasing scent into the water. The beads 140 are inserted into the chamber 112 can make unique sounds when there are no sounds to be naturally made. A variety of bead shapes, sizes, and materials including glass or tungsten can be incorporated into bullet 100. Bead color can be selected including red, blue, chartreuse, or “glow in the dark” colors. Fish can be drawn to bite with just the right sound, depending on the time of the year or whether the water visibility is poor.

As shown in FIGS. 5, 6A, 6B, 7, 8, and 9, the long and short size of the bullet 100 can be selected depending on the intended application. Although the short bullet 100b is specifically intended for a weightless application, though beads 140 of various materials can be added for sounds and/or scent. The present bullet design is also inexpensive to manufacture, reducing the total cost for the end user. The shape or size of either bullet 100a, 100b can be selected for the specific environment in which the bullet will be employed. These size variations may be particularly suited for a given set of underwater obstacles. The color variations may provide the angler with a color selection suitable for the present water conditions. The bullet 100 can be clear to allow visibility of glowing beads, or can be black or improved visibility in dirty or stained water, or can be “green pumpkin” camouflage, a khaki green with black flecks, or any other suitable color.

As shown in FIGS. 16-20, a method can be employed where a fishing line 150 is first threaded through the bullet 100, through a point 160 of the bullet 110. The weight(s), bead(s), and/or scent is then added to the chamber 112, after which the line 150 is tied to the wide gap hook 30. A soft plastic lure 10 is hooked onto to the wide gap hook 30 in accordance with the standard Texas rig method, as understood by those skilled in the art. The bullet 100 is then slid up the line 150 to encapsulate the weight(s), and then placed over the hook eye 32 and the tip of the lure 10 so that the hook shoulder bend 36 is secured through the channels of aperture 120 and over the anchor with a “push, turn, pull” to lock the bullet 100 onto the other aforementioned components.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A fishing lure bullet weight, comprising:
a bullet-shaped exterior body;
a hollow interior chamber surrounded by an inside surface of the exterior body;
an open end at a bottom of the exterior body, wherein the interior chamber is configured to receive and retain a tip of a fishing lure through the open end;
an aperture formed in a side of the exterior body, wherein the aperture is formed as a void space between an outside surface of the exterior body and the inside surface surrounding the hollow interior chamber;
an anchor formed into the side of the exterior body defined by shapes and features of the aperture, wherein the anchor is configured to engage and retain a fishing hook inserted into the chamber and looped through the aperture between the inside and outside surfaces of the exterior body.

2. The fishing lure bullet weight of claim 1, wherein the aperture includes a vertical channel extending upwardly from the open end, wherein the aperture curves from the vertical channel into a horizontal channel parallel to the open end, wherein the aperture curves from the horizontal channel into a tapering channel extending downwardly toward the open end and terminates in a flared channel having a larger opening than the tapered channel.

3. The fishing lure bullet weight of claim 2, wherein the flared channel of the aperture is dimensioned to engage and retain the fishing hook when inserted into the chamber and looped through the aperture between the inside and outside surfaces of the exterior body.

4. The fishing lure bullet weight of claim 3, wherein the flared channel is dimensioned to engage and retain a shoulder bend area of a wide bend fishing hook, so that the hook thereby applies pressure to securely retain the fishing lure inside the chamber against the inside surface of the exterior body.

5. The fishing lure bullet weight of claim 3, wherein the exterior body is formed of a resin having a density less than that of water to form a weightless bullet.

6. The fishing lure bullet weight of claim 1, wherein the exterior body further comprises an open point at an opposite end from the open end for threading a fishing line through the exterior body to the lure and the fishing hook.

7. The fishing lure bullet weight of claim 1, wherein the bullet-shaped exterior body includes a generally cylindrical side wall terminating at the open end and a generally conical tapered tip opposite the open end.

8. The fishing lure bullet weight of claim 1, wherein the hollow interior chamber is sized to receive at least one additional object including: additional weight; light-emitting objects; sound-emitting objects or scent-emitting material.

9. The fishing lure bullet weight of claim 8, wherein the exterior body further comprises at least one vent slot for admitting the passage of light, sound, or scent from the at least one additional object to attract a fish.

10. A method, comprising steps of:
providing a bullet weight comprising an exterior body, a hollow interior chamber, an open end at a bottom of the exterior body, open point at an opposite end from the open end, an aperture formed in a side of the exterior body, and an anchor formed into the side of the exterior body defined by shapes and features of the aperture;
threading a fishing line through the open point;
hooking a fishing lure onto a wide gap hook attached to the fishing line;
sliding the bullet weight along the fishing line to encapsulate a hook eye of the wide gap hook and a tip of the fishing lure so that a shoulder bend of the hook is secured through aperture;
pushing the shoulder bend vertically upwardly into a first channel of the aperture;
turning the shoulder bend horizontally into a second channel of the aperture; and
pulling the shoulder bend vertically downward into a third channel of the aperture into a flared channel to lock the shoulder bend against the anchor, to lock the hook and lure into the bullet.

11. The method of claim 10, wherein, after the step of threading and before the step of sliding, performing a step of adding at least one additional object into the chamber.

12. The method of claim 11, wherein the step of adding at least one additional object comprises adding additional weight; light-emitting objects; sound-emitting objects or scent-emitting material.

13. The method of claim 10, wherein the step of sliding the bullet weight up the line further comprises encapsulating the at least one additional object into the chamber.

14. The method of claim 10, wherein the first channel of the aperture is a vertical channel extending upwardly from the open end, wherein the second channel of the aperture comprises a horizontal channel parallel to the open end that curves away from the vertical channel, wherein the third channel of the aperture comprises a tapering channel extending downwardly toward the open end from the horizontal channel, and terminates in the flared channel having a larger opening than the tapered channel.

15. The method of claim 10, wherein the step of hooking the fishing lure onto the wide gap hook attached to the fishing line is performed in accordance with a standard Texas rig method.
